(19) United States
(12) Patent Application Publication
(10) Pub. No.: US 2017/0052884 A1
(43) Pub. Date: Feb. 23, 2017

(54) GENERIC TEST AUTOMATION FOR RESTFUL WEB SERVICES APPLICATIONS

(71) Applicant: CA, Inc., New York, NY (US)

(72) Inventors: Madhusudhan Ganda, Kadapa (IN); Narendra Dhulipalla, Bangalore (IN); Abhijit Pati, Bengaluru (IN); Vikrant Nandakumar, Bangalore (IN)

(21) Appl. No.: 14/831,050

(22) Filed: Aug. 20, 2015

(51) Int. Cl. G06F 11/36

(52) U.S. Cl. CPC G06F 11/3688

(57) ABSTRACT

A method for testing RESTful web service applications comprises identifying a test case including application-specific interfaces for an application under test. At runtime, the application-specific interfaces are translated to generic REST interfaces and resources using a mapping file, a generic REST library, and reflection. The translated interfaces are then used to test the application.

### CROSS REFERENCE TO RELATED APPLICATIONS

This application is related to U.S. patent application Ser. No. ______ entitled GENERIC TEST AUTOMATION FOR GRAPHICAL USER INTERFACE (GUI) APPLICATIONS by Ganda et al. (Docket No. IN20160039US1/CAT057PA), which is filed concurrently herewith; the entirety of which is incorporated by reference.

### BACKGROUND

Various aspects of the present disclosure relate generally to testing applications and specifically to automated testing of RESTful web services applications. Therefore, the present disclosure advances an improvement in the technical field of application development and testing.

Software applications require extensive testing before being released to the general public to ensure proper functionality. Basically, application-specific test cases (with sets of test operations) application specific test data as an input to a test driver, which is used to test the application.

In modern computing systems, representational state transfer (REST) architecture has become a default for most web and mobile software applications. Applications built on the REST architecture (i.e., RESTful applications) enable a uniform interface for identification of resources, manipulation of the resources, and self-descriptive messages. Software automation tools help test RESTful applications, reducing manual efforts.

During testing, if no exceptions occur, then a verification manager determines whether the test was successful or not and reports either success or an error. Through extensive testing, software developers may ensure a more robust release of the application under test.

### BRIEF SUMMARY

According to aspects of the present disclosure, a method for testing RESTful web service applications comprises identifying a test case including application-specific interfaces for an application under test. At runtime, the application-specific interfaces are translated to generic REST interfaces and resources using a mapping file, a generic REST library, and reflection. The translated interfaces are then used to test the application.

### BRIEF DESCRIPTION OF THE SEVERAL VIEWS OF THE DRAWINGS

FIG. 1 is a flow chart illustrating a method for generic test automation of RESTful applications, according to various aspects of the present disclosure;

FIG. 2 is a flow chart illustrating a method for generic test automation and verification for RESTful applications, according to various aspects of the present disclosure;

FIG. 3 is an example RESTful mapping file specific to an example RESTful application under test, according to various aspects of the present disclosure;

FIG. 4 is an example of a test case in a spreadsheet format used for an example of the method of FIGS. 1-2, according to various aspects of the present disclosure;

FIG. 5 is an example of test data in a spreadsheet format used for an example of the method of FIGS. 1-2, according to various aspects of the present disclosure; and

FIG. 6 is a block diagram of a computer system having a computer readable storage medium for implementing functions according to various aspects of the present disclosure as described in greater detail herein.

### DETAILED DESCRIPTION

According to aspects of the present disclosure, software application test automation is performed using a generic mapping between a test automation tool and application-specific test cases and data. Thus, application-specific test cases (which are a sequence of test steps) and application-specific test data (which supply values to the application test cases) are isolated from the test automation tool and the elements within the application itself in some regard. Basically, a library is created that includes generic RESTful interfaces (e.g., GET, PUT, POST, DELETE, etc.), which are mapped to one or more application-specific interfaces for testing the application in test automation tools.

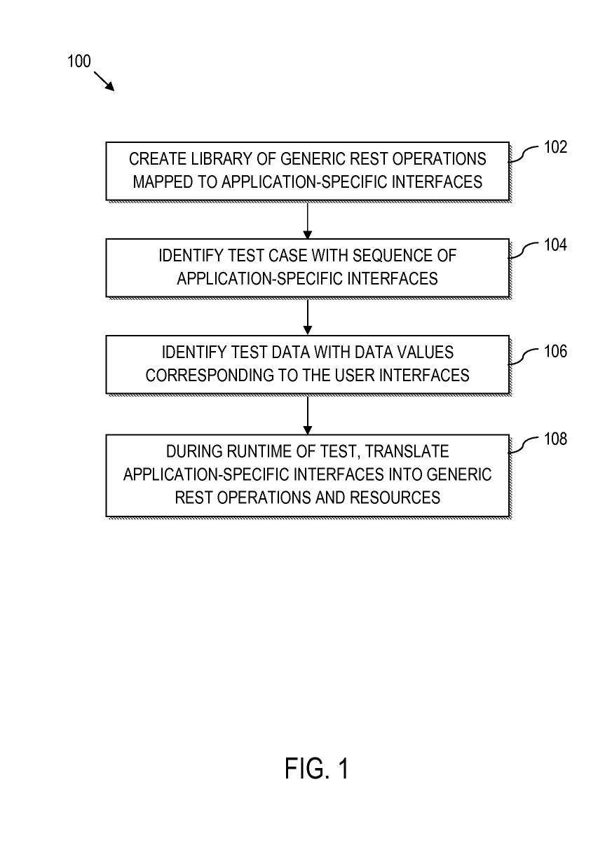

Referring now to FIG. 1, a method 100 for generic test automation of an application is presented. In this regard, the method 100 may be implemented on computer-readable hardware that stores machine-executable program code, where the program code instructs a processor to implement the described method. The method 100 may also be executed by a processor coupled to memory, where the processor is programmed by program code stored in the memory, to perform the described method.

At 102, a library of generic operations is created along with a mapping file that maps the generic operations to interfaces specific to a RESTful web service application. For example, specific to the RESTful web service application under test, an “update user” command of the application may be mapped to a PUT command within the library for the test automation tool, as shown below:
UpdateUser=PUT/users/v1/{cohort}/{userid}

A user may then create an application-specific test case by creating a sequence of the application-specific interfaces. Further, the user may include application-specific test data to supply values for the interfaces within the test case.

At 104, a test case is identified for a RESTful web service application. The test case is a sequence of steps for the automation tool to test the application. The test case may include a sequence of application-specific interface commands (e.g., authenticate) and variable parameters that may be filled in with actual data during run time. For example, an interface command may be:
[UpdateUserData]
cohort=${cohort}
userid=${userid}

The values for ${cohort} and ${userid} may be retrieved at runtime from associated test data. Alternatively, the test case may include the sequence of interfaces with constant parameters hard coded into the test case, as shown below:
[UpdateUserData]
cohort=Cohort_A
userid=User_X

The interfaces of the test case and the test data illustrated above are in a simple key-value pair format. However, the test case may be in any desired format (e.g., extensible markup language (XML), JavaScript Object Notation (JSON), a spreadsheet, etc.). JavaScript is a registered trademark of Sun Microsystems, Inc., a Delaware corporation, located at 4150 Network Circle, Santa Clara, Calif. 95054.

At 106, test data with data values for any variable parameters corresponding to the interfaces are identified. During runtime of the test, values from the test data may be used to provide values for any variable parameters.

The test case (i.e., sequence of application-specific interfaces) is used as an input to the test automation tool, which fills in values for the generic interfaces using the application-specific test data, as discussed above. At 108, during runtime of the test of the RESTful web service application, the interfaces from the test case are translated REST interfaces by referencing the mapping file. Any variable resources within the mapping file are filled in using the data values (either hard coded in the test cases or from the test data). For example, using the UpdateUser command and mapping discussed above, the UpdateUser command is translated to a PUT command using the resource: /users/v1/{cohort}/{userid}. Further, the values for the variables in the resource (e.g., {cohort} and {userid}) are set to the values in the test case, which are: ${cohort} and ${userid}. However, ${cohort} and ${userid} are defined in the test data as Cohort_A and User_X, respectively, so the UpdateUser command is translated to a PUT command with a resource of /users/v1/Cohort_A/User_X. The test automation tool then uses the translated REST command and resource in the testing of the RESTful application.

The method 100 allows a user to create application-specific test cases and application-specific test data using application-specific interfaces (e.g., Authenticate, CreateUser, UpdateUser, etc.) mapped to generic REST interfaces and resources. Thus, users do not need to learn specific scripting or programming languages for test automation. Instead, the users may use plain English to create the application-specific test cases and application-specific test data based on the application-specific interfaces. Further, the method 100 allows portability between tools. For example, if a test is written for a first test automation tool (e.g. httpClient), then to port to a second test automation tool, the generic REST interfaces should map to a definition specific to the test automation tool. Therefore, the user does not need to know which test automation tool will be used to test the application.

For a second RESTful application under test, a new mapping file with application specific interfaces mapped to generic REST functions with resources. Then, the second application is ready for automated testing without any requirement to write automation code.

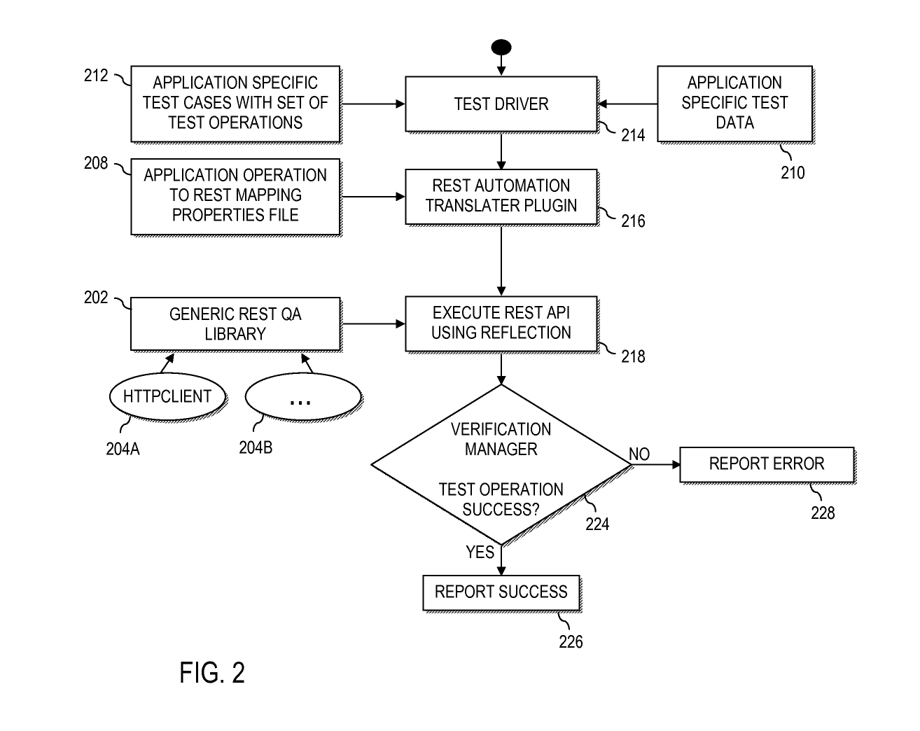

Referring now to FIG. 2, a flow chart illustrates an overall test flow 200 according to various aspects of the present disclosure. A generic library 202 of interface REST interfaces is created for a REST application programming interface (API) of a test automation tool 204. These generic REST interfaces are mapped to application-specific interfaces via an application-specific operation to REST mapping file 208.

When a user wants to test an application (e.g., a RESTful web service application), the user creates application-specific test data 210. The application-specific test data 210 is used in conjunction with application-specific test cases with a set of test operations 212 as input to test driver 214 (in some cases, the application-specific test data may be hard coded in the application-specific test case). Further, the test driver 214 and the application-specific interfaces 208 feed an automation translator plugin 216, which is coupled to the test automation tool and maps operations of the application-specific test cases to application-specific interfaces. At 218, the test automation tool executes the application-specific interfaces 208 using reflection the generic REST interfaces 202. Basically, the test driver reads the application-specific test case 212 and references the application-specific test data 212 to retrieve values for variables of the first interface command. Then, the first interface command is simulated using the generic REST interfaces. Thus, at runtime, the application-specific interfaces are translated to the generic REST interfaces (including resources).

When the test case has been completed, a verification manager verifies the results at 224. For example, a user may supply a sequence that determined if a certain response is received from the application. The verification sequence may be part of the application-specific test case or may be separate from the application-specific test case. If the test automation is successful, then the verification manager reports success at 226; otherwise, an error is reported at 228.

The verification manager may use the generic interfaces as described herein for the application-agnostic REST verification sequence.

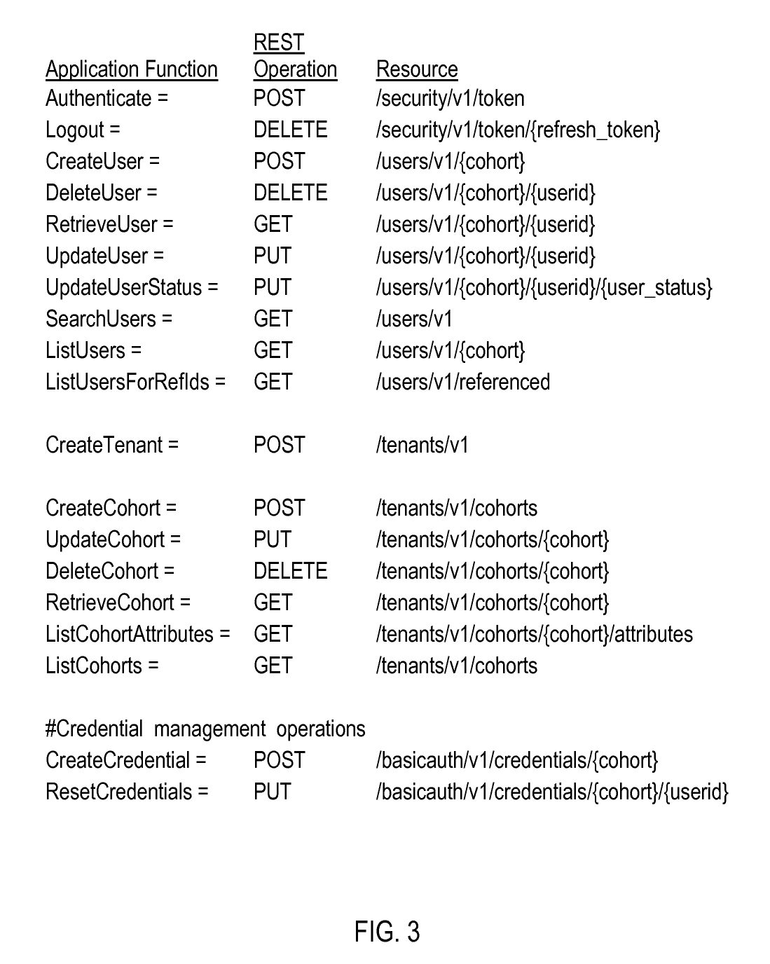

FIGS. 3-5 illustrate an example of a test automation of a RESTful application, according to aspects of the methods above. FIG. 3 illustrates a mapping of application-specific interface commands to a REST operations and resources, which are defined in the generic library.

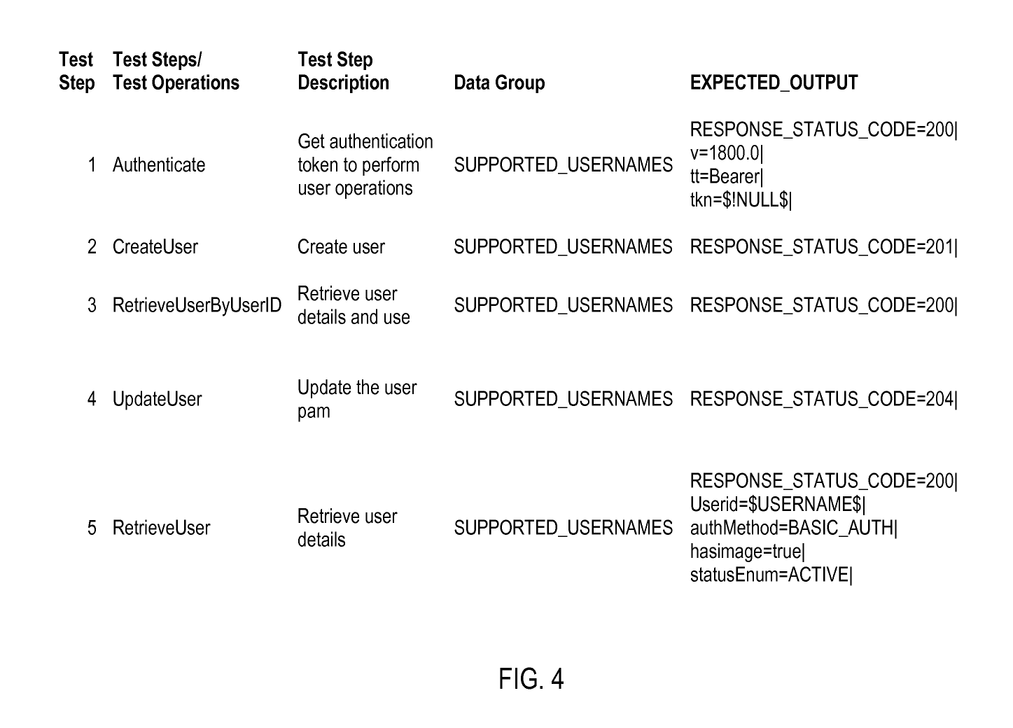

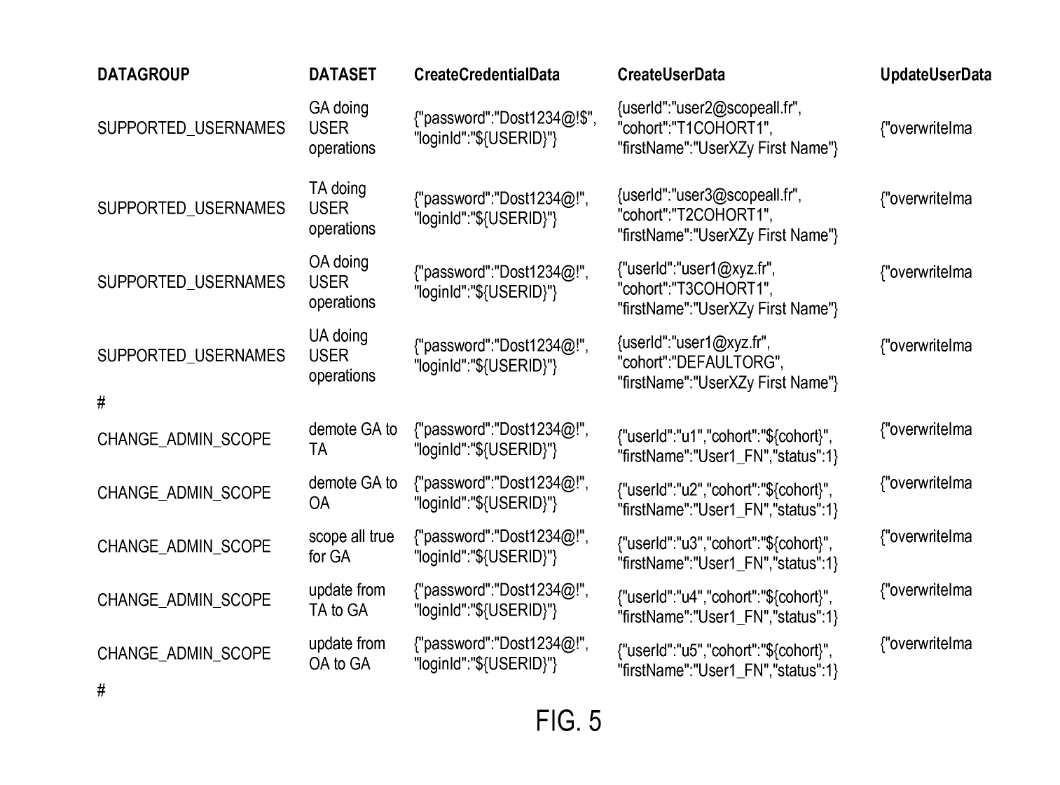

An example test case and test data are illustrated in FIGS. 4-5. Specifically, the test case of FIG. 4 includes five application-specific interfaces to be completed in order: Authenticate, CreateUser, RetrieveUserByUserID, UpdateUser, and RetrieveUser. Each of the application-specific interfaces includes a reference to a data group from the data set (FIG. 5), which in this case is a SUPPORTED_USERNAMES data group. Further, each application-specific interface includes an EXPECTED_OUTPUT for verification that the RESTful application is functioning properly.

FIG. 5 illustrates test data for the example. As shown, the test data has a DATAGROUP heading that maps to the data group from the test case. The other columns within the test data correspond to different user operations. As shown, there are two full columns of test data (one for CreateCredentialData and the other for CreateUserData) and a partial column of UpdateUserData, which is included to indicate that there may be as many columns as needed to test the RESTful application properly. For example, there may be columns for RetrieveUserByUserIdData, RetrieveUserData, etc. In the embodiment shown, the test data is written in JSON format, but as mentioned above, the test data may be in any desired format.

When running a test of the RESTful application, the application-specific test case and the application-specific test data are read in by the test driver, which feeds a REST automation translator plugin. The first interface is read in, which in this case is Authenticate. The REST automation translator plugin translates Authenticate to a POST operation with a resource of /security/v1/token. There are no variable parameters within the resource, so the application-specific test data does not need to be referenced for the resource.

The POST operation and resource are sent along with a loginId and password found in the CreateCredentialData column of the test data, and a response is received. In this case, the response includes a non-null token (tkn), a RESPONSE_STATUS_CODE of 200, a period that the token is valid (v) of 1800 seconds, and a token type (tt) of Bearer. A validation manager compares the response to an EXPECTED_OUTPUT from the test case, and in this case, the response matches the expected output. Thus, the first operation is a success.

The second operation is then sent to the REST automation translator plugin. In this case, the operation is a CreateUser operation, which the REST automation translator plugin translates to a POST command with a resource of /users/v1/{cohort} using the mapping file and the generic REST interface library. Because the resource is a variable (indicated by the curly brackets of {cohort}), the value for the resource will be modified by the test data. In this case, the cohort in the test data is set to “T1COHORT1”, so the resource is /users/v1/T1COHORT1. The rest of the data in the JSON object of the test data is also sent with the POST command and resource to create a user with a UserId of user2@scopeall.fr and a FirstName of “UserXZy First Name”. Other parameters may be sent that are not shown in this example (e.g., LastName, Password, ConfirmPassword, etc.). The translated POST command is sent, and a response is received, which includes a RESPONSE_STATUS_CODE of 201. The verification manager compares the EXPECTED_OUTPUT to the received response and determines that the CreateUser operation was a success.

The other operations in the application-specific test case are run in the same manner where the REST automation translator plugin translates the operation to a REST command within the generic REST library by using the mapping file of FIG. 3. Further, any variable resources found within the mapping file can be populated with information from the application-specific test data. Moreover, more than one portion of a resource may be variable. For example, the UpdateUserStatus includes a PUT command and a resource of /users/v1/{cohort}/{userid}/{user status}. Thus, values for cohort, userid, and user_status found in the application-specific test data may be substituted in to create a resource identifier. As indicated above, the application-specific test data also includes values for the application-specific interface required to properly test the RESTful application. Further, the test data may be hard coded into the application-specific test case instead of having a separate file for the test data.

Once all of the operations of the application-specific test case are run and verified, the verification manager will indicate success or failure of the test (compared to the expected results). In the embodiment above, the individual operations are verified as they occur, but in some embodiments, all (or some) of the operations may be run before the results are verified.

The generic REST interfaces in conjunction with the REST automation translator plugin allow a user to write application-specific test cases and application-specific test data without knowing any specific scripting language or test automation tool language.

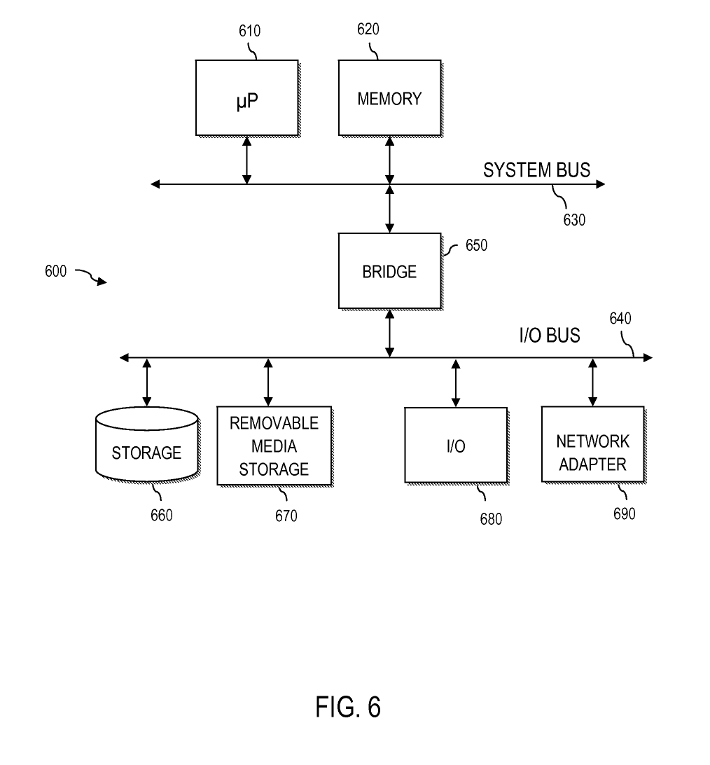

Referring to FIG. 6, a block diagram of a data processing system is depicted in accordance with the present disclosure. Data processing system 600 may comprise a symmetric multiprocessor (SMP) system or other configuration including a plurality of processors 610 connected to system bus 620. Alternatively, a single processor 610 may be employed. Also connected to system bus 620 is memory controller/cache 630, which provides an interface to local memory 640. An I/O bus bridge 650 is connected to the system bus 620 and provides an interface to an I/O bus 660. The I/O bus may be utilized to support one or more buses and corresponding devices 670, such as bus bridges, input output devices (I/O devices), storage, network adapters, etc. Network adapters may also be coupled to the system to enable the data processing system to become coupled to other data processing systems or remote printers or storage devices through intervening private or public networks.

Also connected to the I/O bus may be devices such as a graphics adapter 680, storage 690 and a computer usable storage medium 695 having computer usable program code embodied thereon. The computer usable program code may be executed to implement any aspect of the present disclosure, for example, to implement any aspect of any of the methods and/or system components illustrated in FIGS. 1-5.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer storage medium does not include propagating signals.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Network using an Network Service Provider).

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. Aspects of the disclosure were chosen and described in order to best explain the principles of the invention and the practical application, and to enable others of ordinary skill in the art to understand the invention for various embodiments with various modifications as are suited to the particular use contemplated.

1. A method comprising:
identifying a test case for an application under test, wherein the test case includes application specific interfaces, which are not based on a specific scripting or programming language;
translating the application specific interfaces of the test case to representational state transfer (REST) interfaces, wherein the translating is performed during runtime of a test of the application under test; and
sending the translated application specific interfaces to the application under test.

2. The method of claim 1, wherein translating the application specific interfaces of the test case to REST interfaces further comprises referencing a library comprising generic REST interfaces for the test automation tool.

3. The method of claim 2, wherein translating the application specific interfaces of the test case to REST interfaces further comprises referencing a mapping file that maps the application specific interfaces to the generic REST interfaces.

4. The method of claim 3, wherein referencing a mapping file that maps the application specific interfaces to the generic REST interfaces further comprises referencing a mapping file that maps the application specific interfaces to the generic REST interfaces and resources.

5. The method of claim 4, wherein:
referencing a mapping file that maps the application specific interfaces to the generic REST interfaces and resources further comprises referencing a mapping file that maps the application specific interfaces to the generic REST interfaces and variable resources; and
the method further comprises:
identifying application-specific test data with data values corresponding to the application specific interfaces; and
filling in the variable resources of the translated REST interfaces using the data values corresponding to the application specific interfaces.

6. The method of claim 1, wherein translating the application specific interfaces of the test case to representational state transfer (REST) interfaces is performed by a plug-in that is separate from the test automation tool, yet coupled to the test automation tool.

7. The method of claim 1 further comprising:
receiving a response from the application under test;
comparing the response to an expected response defined in the test case;
issuing an error message if the response does not match the expected response defined in the test case; and
issuing a success message if the response does match the expected response defined in the test case.

8. The method of claim 1, wherein identifying a test case for an application under test, wherein the test case includes application specific interfaces further comprises identifying a test case for an application under test, wherein the test case includes application specific interfaces, wherein the application specific interfaces of the test case do not include REST interfaces.

9. A system comprising a hardware processor coupled to memory, wherein the processor is programmed to test an application by:
identifying a test case for an application under test, wherein the test case includes application specific interfaces, which are not based on a specific scripting or programming language;
translating the application specific interfaces of the test case to representational state transfer (REST) interfaces, wherein the translating is performed during runtime of a test of the application under test; and
sending the translated application specific interfaces to the application under test.

10. The system of claim 9, wherein translating the application specific interfaces of the test case to REST interfaces further comprises referencing a library comprising generic REST interfaces for the test automation tool.

11. The system of claim 10, wherein translating the application specific interfaces of the test case to REST interfaces further comprises referencing a mapping file that maps the application specific interfaces to the generic REST interfaces.

12. The system of claim 11, wherein referencing a mapping file that maps the application specific interfaces to the generic REST interfaces further comprises referencing a mapping file that maps the application specific interfaces to the generic REST interfaces and resources.

13. The system of claim 12, wherein:
referencing a mapping file that maps the application specific interfaces to the generic REST interfaces and resources further comprises referencing a mapping file that maps the application specific interfaces to the generic REST interfaces and variable resources; and
the processor is further programmed to perform:
identifying application-specific test data with data values corresponding to the application specific interfaces; and
filling in the variable resources of the translated REST interfaces using the data values corresponding to the application specific interfaces.

14. The system of claim 9, wherein translating the application specific interfaces of the test case to representational state transfer (REST) interfaces is performed by a plug in that is separate from the test automation tool, yet coupled to the test automation tool.

15. The system of claim 9 further comprising:
receiving a response from the application under test;
comparing the response to an expected response defined in the test case;
issuing an error message if the response does not match the expected response defined in the test case; and
issuing a success message if the response does match the expected response defined in the test case.

16. The system of claim 9, wherein identifying a test case for an application under test, wherein the test case includes application specific interfaces further comprises identifying a test case for an application under test, wherein the test case includes application specific interfaces, wherein the application specific interfaces of the test case do not include REST interfaces.

17. Computer-readable hardware with program code stored thereon, wherein the program code instructs a hardware processor to perform:
identifying a test case for an application under test, wherein the test case includes application specific interfaces, which are not based on a specific scripting or programming language;
translating the application specific interfaces of the test case to representational state transfer (REST) interfaces by referencing a mapping file that maps the application specific interfaces to the REST interfaces and resources associated with the REST interfaces, wherein the translating is performed during runtime of a test of the application under test; and
sending the translated application specific interfaces to the application under test.

18. The computer-readable hardware of claim 17, wherein:
translating the application specific interfaces of the test case to representational state transfer (REST) interfaces by referencing a mapping file that maps the application specific interfaces to the REST interfaces and resources associated with the REST interfaces further comprises referencing a mapping file that maps the application specific interfaces to the generic REST interfaces and variable resources; and
the program code further instructs the processor to perform:
identifying application-specific test data with data values corresponding to the application specific interfaces; and
filling in the variable resources of the translated REST interfaces using the data values corresponding to the application specific interfaces.

19. The computer-readable hardware of claim 17, wherein translating the application specific interfaces of the test case to representational state transfer (REST) interfaces is performed by a plug-in that is separate from the test automation tool, yet coupled to the test automation tool.

20. The computer-readable hardware of claim 17, wherein identifying a test case for an application under test, wherein the test case includes application specific interfaces further comprises identifying a test case for an application under test, wherein the test case includes application specific interfaces, wherein the application specific interfaces of the test case do not include REST interfaces.
